(19) United States
(12) Patent Application Publication
(10) Pub. No.: US 2026/0368649 A1
(43) Pub. Date: Nov. 19, 2026

(54) INFORMATION RECOMMENDATION METHOD AND APPARATUS, DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventors: Tianyue CAO, Shenzhen (CN); Shuo YANG, Shenzhen (CN); Shengbin JIA, Shenzhen (CN)

(73) Assignee: TENCENT TECHNOLOGY (SHENZHEN) COMPANY LIMITED, Shenzhen (CN)

(21) Appl. No.: 19/731,761

(22) Filed: Jul. 6, 2026

Related U.S. Application Data
(63) Continuation of application No. PCT/CN2025/100966, filed on Jun. 13, 2025.

(30) Foreign Application Priority Data
Aug. 7, 2024 (CN) 202411082902.4

(51) Int. Cl. G06N 20/00

(52) U.S. Cl. CPC G06N 20/00

(57) ABSTRACT

An information recommendation method, apparatus, and computer-readable storage medium for accurate recommendations through graph-based feature learning. The method obtains object data of recommendation target objects and to-be-recommended information. Training sample graphs are sampled to obtain corresponding training subgraphs, which are used together with the sample graphs to train a feature extraction model. The trained model performs feature extraction on object data and to-be-recommended information to obtain object features and information features respectively. Target to-be-recommended information matching each recommendation target object is determined based on these features. The matching information is sent to terminals of the recommendation target objects for display. This approach enables precise information recommendation by leveraging graph structure learning through subgraph sampling to capture rich relational features for effective object-information matching.

### CROSS-REFERENCE TO RELATED APPLICATIONS

This application is a continuation application of International Application No. PCT/CN2025/100966 filed on Jun. 13, 2025 which claims priority to Chinese Patent Application No. 202411082902.4, filed with the China National Intellectual Property Administration on Aug. 7, 2024, the disclosures of each being incorporated by reference herein in their entireties.

### FIELD

The disclosure relates to the field of machine learning and data mining technologies, an information recommendation method and apparatus, a device, a computer-readable storage medium, and a computer program product.

### BACKGROUND

In an age of information explosion, users are faced with massive amounts of information to choose from. A recommendation system can help the users quickly find information in which the users are interested or that the users need, to reduce time and difficulty for the users in searching for information. The recommendation system can further provide personalized content, so that each user can obtain a recommendation that best satisfies a requirement of the user, thereby improving user satisfaction and user experience. The recommendation system may further balance various types of content by using an algorithm, to ensure that diversified information is presented, thereby satisfying requirements of different users. The recommendation system may also help disseminate and promote valuable content, such as education, health, and culture, thereby positively affecting society and culture.

In the related art, a model for feature extraction is obtained in an unsupervised learning manner. In this way, when the model is used for feature extraction, features having uncontrollable quality are obtained, in other words, the obtained features have poor effectiveness and low accuracy. Consequently, recommendation accuracy is reduced, affecting effectiveness of a recommendation result.

### SUMMARY

Provided are an information recommendation method and apparatus, a device, a storage medium, and a program product, which can implement accurate information recommendation through graph-based feature extraction model training using sampled subgraphs and object-information feature matching.

According to some embodiments, an information recommendation method, performed by a computer device, includes: obtaining first object data of a plurality of recommendation target objects and a plurality of pieces of to-be-recommended information; sampling each training sample graph of a plurality of training sample graphs to obtain at least one training subgraph corresponding to the training sample graph; training a feature extraction model based on the plurality of training sample graphs and the at least one training subgraph corresponding to each training sample graph; performing feature extraction on the first object data and the to-be-recommended information using the feature extraction model, to obtain object features and information features, respectively; determining, based on the object features and the information features, target to-be-recommended information matching each recommendation target object; and sending the target to-be-recommended information matching each recommendation target object to a terminal of the recommendation target object, to cause the terminal to display the target to-be-recommended information to the recommendation target object.

According to some embodiments, an information recommendation apparatus, includes: at least one memory configured to store program code; and at least one processor configured to read the program code and operate as instructed by the program code, the program code including: obtaining code configured to cause at least one of the at least one processor to obtain first object data of a plurality of recommendation target objects and a plurality of pieces of to-be-recommended information; sampling code configured to cause at least one of the at least one processor to sample each training sample graph of a plurality of training sample graphs to obtain at least one training subgraph corresponding to the training sample graph; training code configured to cause at least one of the at least one processor to train a feature extraction model based on the plurality of training sample graphs and the at least one training subgraph corresponding to each training sample graph; extraction code configured to cause at least one of the at least one processor to perform feature extraction on the first object data and the to-be-recommended information using the feature extraction model, to obtain object features and information features, respectively; determination code configured to cause at least one of the at least one processor to determine, based on the object features and the information features, target to-be-recommended information matching each recommendation target object; and sending code configured to cause at least one of the at least one processor to send the target to-be-recommended information matching each recommendation target object to a terminal of the recommendation target object, to cause the terminal to display the target to-be-recommended information to the recommendation target object.

According to some embodiments, a non-transitory computer-readable storage medium, storing computer code which, when executed by at least one processor, causes the at least one processor to at least: obtain first object data of a plurality of recommendation target objects and a plurality of pieces of to-be-recommended information; sample each training sample graph of a plurality of training sample graphs to obtain at least one training subgraph corresponding to the training sample graph; train a feature extraction model based on the plurality of training sample graphs and the at least one training subgraph corresponding to each training sample graph; perform feature extraction on the first object data and the to-be-recommended information using the feature extraction model, to obtain object features and information features, respectively; determine, based on the object features and the information features, target to-be-recommended information matching each recommendation target object; and send the target to-be-recommended information matching each recommendation target object to a terminal of the recommendation target object, to cause the terminal to display the target to-be-recommended information to the recommendation target object.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of skill in the art may still derive other drawings from these accompanying drawings without creative efforts. In addition, one of skill would understand that aspects of some embodiments may be combined together or implemented alone.

FIG. 1 is a schematic diagram of a framework structure for obtaining a feature representation through a graph neural network in the related art.

FIG. 2 is a schematic diagram of a network architecture of an information recommendation system 100 according to some embodiments.

FIG. 3 is a schematic diagram of a structure of a server 400 according to some embodiments.

FIG. 4 is a schematic flowchart of an information recommendation method according to some embodiments.

FIG. 5 is a schematic flowchart of a model training method according to some embodiments.

FIG. 6 is a schematic flowchart of constructing a training sample graph and a training subgraph according to some embodiments.

FIG. 7 is a schematic flowchart of determining a total loss value according to some embodiments.

FIG. 8 is a schematic flowchart for determining target to-be-recommended information according to some embodiments.

FIG. 9 is a schematic diagram of an implementation framework of a network structure according to some embodiments.

### DESCRIPTION OF EMBODIMENTS

To make the objectives, technical solutions, and advantages of this application clearer, the following further describes this application in detail with reference to the accompanying drawings. The described embodiments are not to be considered as a limitation on this application. All other embodiments obtained by a person of skill in the art without creative efforts shall fall within the protection scope of this application.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In the following descriptions, the term “some embodiments” describes a subset of all possible embodiments. However, “some embodiments” may be the same subset or different subsets of all possible embodiments, and may be combined with each other without conflict.

In the following description, the terms “first”, “second”, and “third” are merely intended to distinguish between similar objects rather than describe orders. The terms “first”, “second”, and “third” may, where permitted, be interchangeable in a particular order or sequence, so that some embodiments described herein may be performed in an order other than that illustrated or described herein.

In some embodiments, a term “module” or “unit” is a computer program having a predetermined function or a part of a computer program, and operates together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

Unless otherwise defined, meanings of all technical and scientific terms used in some embodiments are the same as those usually understood by a person skilled in the art. Terms used in some embodiments are merely intended to describe objectives of some embodiments, but are not intended to limit this application.

In some embodiments, collection and processing of related data need to strictly comply with relevant laws and regulations during actual application, informed consent or separate consent of the personal information subject needs to be obtained, and subsequent data is used and processed within the scope of authorization of laws and regulations and the personal information subject.

Before some embodiments are further described in detail, a description is made on terms involved in some embodiments, and the terms in some embodiments are applicable to the following explanations.

(1) Recommendation system: The recommendation system is an information filtering system intended to provide a user with personalized recommendations for information, items, or services from a large amount of content or items. An objective of the recommendation system is to help the user quickly find content in which the user is interested from massive amounts of data, while improving user satisfaction and a commercial value of a platform.

The recommendation system is widely applied to a plurality of fields, including e-commerce, content platforms, social media, advertising, education, learning, and the like.

A core of the recommendation system is to learn user behavior patterns and user preferences, and then use the information to predict interest of the user in unseen items. Common recommendation algorithms include collaborative filtering, content-based recommendation, a hybrid recommendation system, and the like. Design and optimization of the recommendation system is a continuously evolving field. With the development of technologies, the recommendation system is becoming more accurate and intelligent.

(2) Graph: The graph is a data structure, and includes nodes (or vertexes) and edges. A node represents an entity, and an edge represents a relationship between nodes.

The graph may be configured for representing a plurality of types of data and structures, for example:
1. Social network: In the social network, a node represents an individual, and an edge represents a social relationship between individuals.
2. Transportation network: In an urban transportation network, a node represents a road or an intersection, and an edge represents a path or street connecting these nodes.
3. Biological network: In biological science, a graph may be configured for representing a protein interaction network, where a node represents a protein, and an edge represents an interaction between proteins.
4. Recommendation system: In a recommendation system, a graph may be configured for representing an interaction history between a user and an item, where nodes represent the user and the item, and an edge represents a user preference for the item or an interaction between the user and the item.
5. Knowledge graph: The knowledge graph is a large-scale knowledge base. In the graph, a node represents an entity (such as a person, a location, or a thing), and an edge represents a relationship between entities.

A graph is a highly flexible and powerful data structure, and may be configured for handling various complex tasks, such as shortest path, connectivity, community detection, and network analysis. In graph theory and graph algorithms, a large amount of research is devoted to graph properties, graph representations, and how to effectively perform computation and analysis on a graph.

(3) Subgraph: The subgraph is a graph obtained by graph sampling. Graph sampling is a Used technology intended to extract a part of data from an original graph, to perform effective learning and analysis under limited computing resources.

Operations of graph sampling generally include: node sampling, edge sampling, subgraph construction, and a sampling strategy. A subgraph sampled from an original graph may be obtained through sampling. The subgraph may be configured for training in a graph neural network, or configured for research in graph analysis, without processing the entire original graph.

(4) Contrastive learning: Contrastive learning is a deep learning method, and a core idea thereof is to learn data representations by comparing similarities and differences between different data samples. In this method, a model is trained to distinguish which samples are similar to each other and which samples are dissimilar in feature space. Specifically, positive pairs and negative pairs are usually generated through contrastive learning.

The positive pairs are obtained by performing data augmentation on the same original data sample in different manners (such as rotation, scaling, and cropping). These augmented samples are essentially similar because the augmented samples are all derived from the same entity. The model needs to learn that, in feature representation space, these positive pairs are close to each other.

The negative pairs include augmented images from different original data samples. These images may be visually somewhat similar to the positive pairs, but are actually different in meaning. The model needs to learn to push these negative pairs away from each other in feature space.

Contrastive learning mainly includes operations such as data augmentation, an encoder network, a projection network, and a contrastive loss function.

A key advantage of a contrastive learning method is that a useful representation can be learned from unlabeled data. This is of great significance for improving a generalization capability of the model and reducing dependency on a large-scale labeled dataset. In addition, a feature representation learned through contrastive learning may also be applied to another related task through transfer learning.

(5) Graph neural networks (GNNs): The graph neural network is a neural network architecture, and is specially configured to process graph-structured data. Graph data is a set formed by nodes (entities) and edges (relations), and is widely applied to various fields such as a social network, a knowledge graph, molecular chemistry, a recommendation system, and a transportation network. Unlike a neural network, the GNNs, when processing data, not only consider features of each node, but also consider a network structure and a mutual relationship between nodes.

A core idea of the graph neural network is to update node representations by using a message passing mechanism. Specifically, a node receives a message from a neighboring node of the node, and integrates the message with a feature of the node, to update a representation of the node. The process may be repeated, so that a representation of each node gradually includes more information about the node and neighbor nodes of the node.
components of a graph neural network include: a node feature, an edge feature, message passing, message aggregation, and a node update.

Some variants of the graph neural network, such as a graph convolutional network (GCN), a graph attention network (GAT), a graph isomorphism network (GIN), and a message passing neural network (MPNN), further expand a function and an application range of the graph neural network by using different neural network architectures and information passing mechanisms.

(6) Pre-training method: A pre-training method is an unsupervised or semi-supervised learning process performed on original data, to learn good feature representations, where the feature representations may be configured for downstream tasks. The pre-training is usually performed on large-scale unlabeled data, to enable the model to learn feature representations having a good generalization capability, thereby achieving good performance on different downstream tasks.

An objective of the pre-training method is to enable a model to learn rich and general feature representations by performing learning on large-scale data, and these feature representations may better represent an internal rule and pattern of original data. A pre-trained model may be fine-tuned on different downstream tasks, to achieve good performance. Fine-tuning is to adjust the pre-trained model on a downstream task, so that the pre-trained model adapts to a particular requirement of the downstream task. Performance of the model on various downstream tasks can be significantly improved through pre-training and fine-tuning.

In conclusion, the pre-training method is a method of performing unsupervised or semi-supervised learning on large-scale unlabeled data, to learn a feature representation having generality and a generalization capability, thereby improving performance of a model on various downstream tasks. Pre-training can improve a generalization capability of a model, reduce dependency on labeled data, and improve performance of the model on unseen data.

(7) Noise distribution: In a contrastive learning or negative sampling task for a graph, a noise distribution is a distribution function configured for generating a “false” or “irrelevant” node pair. The “false” or “irrelevant” node pair is used as a negative sample to train a model to distinguish a true connection (a positive sample) and a false connection (a negative sample).

To better understand the information recommendation method provided in some embodiments, an information recommendation method in the related art and the existing shortcomings thereof are first described.

A graph, as a set including nodes and edge relationships between the nodes, is widely present in a plurality of scenarios in the real world, for example, a graph of social relationships between people in a social network and a graph of interactions between users and items in a recommendation system. A graph neural network can capture features of nodes and edges and a topological relationship between the nodes and the edges, and therefore has a good modeling effect on graph-structured data. In the related art, graph neural network models Used in a recommendation system may be classified into two main categories: a graph walk-based method and a graph convolution-based method.

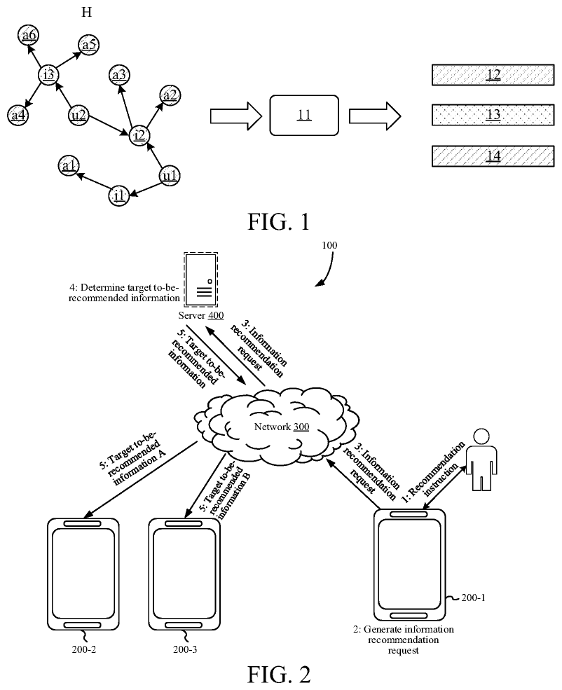

A first category is a graph walk-based method. A neural network model is good at processing data in Euclidean space, but has difficulty in modeling a complex topological relationship included in a graph structure. Therefore, early researchers proposed an indirect solution of sampling a sequence from graph-structured data by using a walk method, and then processing the sequence by using a neural network model. Typical representative works include DeepWalk, Node2vec, and the like. As shown in FIG. 1, this type of method focuses on generating a node sequence in a graph by using a predetermined walk strategy, and then obtaining a vector representation of each node through training by using a Skip-Gram model in the field of natural language processing (NLP).

In FIG. 1, a heterogeneous graph H is established for a user-item-advertisement scenario. The heterogeneous graph H includes users u1 and u2, includes items i1, i2, and i3, and further includes advertisements a1, a2, a3, a4, a5, and a6. Feature aggregation and propagation are performed through a graph neural network 11, to obtain a user feature representation 12, an item feature representation 13, and an advertisement feature representation 14, which are directly configured for retrieval or used as features for a model. The method is an unsupervised method, and therefore quality of features is uncontrollable. In addition, noise in a graph causes the learned features to be unstable.

A second category is a graph convolution-based method: A manner of sampling a sequence from a graph for modeling is simple and direct. However, because information is lost during conversion from an original graph structure to a sequence, an effect of the method is limited. Therefore, how to directly model a graph structure into a neural network becomes a key problem in graph neural network research. Researchers define a convolution operation on a graph based on Fourier transform of a graph signal in spectral domain, and associate spectral graph convolution with a neural network through a series of simplifications.

From the perspective of an entire graph, a graph convolutional network (GCN) breaks a barrier between an original graph structure and a neural network. However, a huge amount of computation makes it difficult to apply the graph convolutional network to a large-scale scenario. In comparison, from the perspective of nodes on a graph, graph sample and aggregation (GraphSage) provides a sampling-based message passing paradigm, so that efficient computation of a graph neural network on a large-scale graph becomes feasible. In a graph neural network method based on a message passing paradigm, for example, GraphSage, a range of features that a central node can aggregate depends on an order of a sampled neighbor of the central node. When such a graph neural network is used for training, in addition to using inherent features of a node as model inputs, an independently trainable vector parameter may further be added to each node, to better learn correlation of higher-order neighbors.

In addition to the two categories of methods mentioned above, the field of graph neural networks is one of research hotspots. Algorithms such as GAT, FastGCN, and GIN have continuously emerged in recent years, and achieve good effects in a large-scale recommendation scenario.

In the related art, general-purpose graph neural network pre-training methods all use an unsupervised learning manner. As a result, quality of a learned feature representation is uncontrollable. This reduces effectiveness and accuracy of the feature representation, and affects a recommendation effect. In addition, noise is not processed in a learning process, causing the learned feature representation to be unstable.

It can be learned from the foregoing related art that disadvantages of the related art include at least the following. First, accuracy of a feature representation is low. Second, a recommendation effect is poor. Third, stability of the feature representation is low.

Some embodiments provide an information recommendation method and apparatus, a computer device, a computer-readable storage medium, and a computer program product, to improve recommendation accuracy, and improve stability and overall performance of a recommendation system. The following describes exemplary applications of the computer device provided in some embodiments. The computer device provided in some embodiments may be implemented as various types of terminals such as a notebook computer, a tablet computer, a desktop computer, a set-top box, a smartphone, a smart speaker, a smartwatch, a smart television, and an in-vehicle terminal, or may be implemented as a server. The following describes an exemplary application in which the computer device is implemented as a server.

FIG. 2 is a schematic diagram of a network architecture of an information recommendation system 100 according to some embodiments. To support an information recommendation application, a server 400 is connected to a terminal 200-1, a terminal 200-2, and a terminal 200-3 through a network 300. The network 300 may be a wide area network, a local area network, or a combination thereof. The terminal 200-1 is a terminal triggering information recommendation, and the terminal 200-2 and the terminal 200-3 are terminals of different recommendation target objects.

The terminal 200-1 is configured to receive a recommendation instruction for a plurality of recommendation target objects, and generate an information recommendation request for the plurality of recommendation target objects. The terminal 200-1 further sends the information recommendation request to the server 400. The terminal 200-1 also sends first object data of the plurality of recommendation target objects and a plurality of pieces of to-be-recommended information to the server 400. The server 400 is configured to: separately perform feature extraction on the first object data and the to-be-recommended information by using a trained feature extraction model, to correspondingly obtain object features and information features, the trained feature extraction model being obtained by training a to-be-trained feature extraction model based on a plurality of training sample graphs and at least one training subgraph corresponding to each training sample graph, and the training subgraph being obtained by performing graph sampling on the training sample graph; and determine, based on the plurality of object features and the plurality of information features, target to-be-recommended information matching each recommendation target object. The server 400 further sends the target to-be-recommended information to terminals (the terminal 200-2 and the terminal 200-3 shown in the figure) of the recommendation target objects, so that the terminal 200-2 and the terminal 200-3 display pieces of target to-be-recommended information respectively corresponding to the recommendation target objects. Still refer to FIG. 2. Assuming that the terminal 200-2 is a terminal of a recommendation target object a, and target to-be-recommended information matching the recommendation target object a is target to-be-recommended information A, the target to-be-recommended information A is sent to the terminal 200-2. Similarly, assuming that the terminal 200-3 is a terminal of a recommendation target object b, and target to-be-recommended information matching the recommendation target object b is target to-be-recommended information B, the target to-be-recommended information B is sent to the terminal 200-3. In some embodiments, the terminal 200-1 may be a terminal of a recommendation target object. In this case, the server 400 may send target to-be-recommended information corresponding to the recommendation target object to the terminal 200-1. In addition, in FIG. 2, an example in which terminals of the recommendation target objects are the terminal 200-2 and the terminal 200-3 is used. A quantity of the terminals of the recommendation target object matches an actual situation. For example, the quantity of the terminals of the recommendation target object may be three, four, five, or more.

In some embodiments, the trained feature extraction model used by the server 400 for feature extraction is obtained through training based on a plurality of training sample graphs and at least one training subgraph corresponding to each training sample graph rather than being obtained through training based only on the plurality of training sample graphs, and the training subgraph is obtained by performing graph sampling on the training sample graph. In this way, self-supervised contrastive learning can be implemented based on the training sample graphs and the training subgraphs, in other words, the trained feature extraction model can be obtained through self-supervised contrastive learning. Based on this, when feature extraction is performed on the first object data and the to-be-recommended information by using the trained feature extraction model, object features and information features with controllable quality can be obtained, in other words, object features and information features with high reliability, high accuracy, and generalization capabilities can be obtained. Therefore, target to-be-recommended information with a high matching degree and high accuracy can be determined based on the object features and the information features with high reliability, high accuracy, and generalization capabilities, thereby improving recommendation accuracy, and improving stability and overall performance of the recommendation system.

In some embodiments, the server 400 may be an independent physical server, a server cluster or distributed system including a plurality of physical servers, or a cloud server providing cloud computing services such as a cloud service, a cloud database, cloud computing, a cloud function, a cloud storage, a network service, cloud communication, a middleware service, a domain name service, a security service, a content delivery network (CDN), and a big data and artificial intelligence platform. The terminal and the server may be connected directly or indirectly in a wired or wireless communication manner. This is not limited in some embodiments.

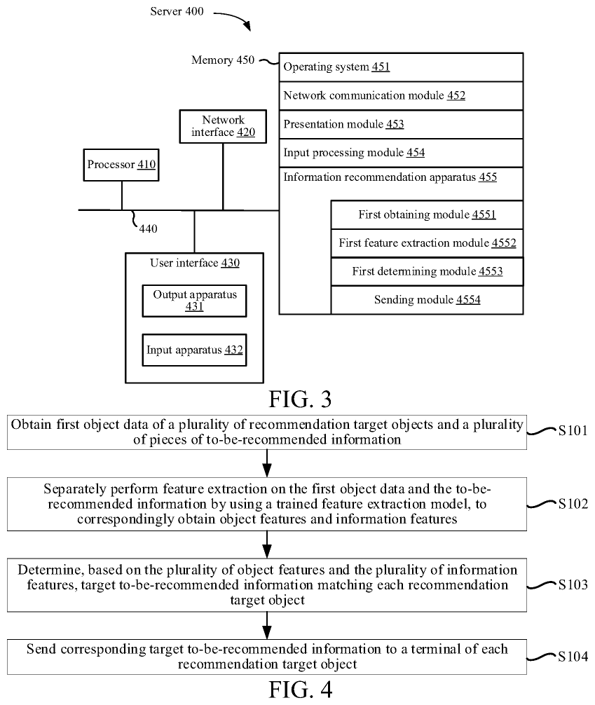

FIG. 3 is a schematic diagram of a structure of a server 400 according to some embodiments. The server 400 shown in FIG. 3 includes: at least one processor 410, a memory 450, at least one network interface 420, and a user interface 430. Components in the server 400 are coupled together through a bus system 440. The bus system 440 is configured to implement connection and communication between the components. In addition to a data bus, the bus system 440 further includes a power bus, a control bus, and a status signal bus. However, for ease of clear description, various types of buses are marked as the bus system 440 in FIG. 3.

The processor 410 may be an integrated circuit chip with a signal processing capability, such as a general-purpose processor, a digital signal processor (DSP), or another programmable logic device, discrete gate, transistor logic device, discrete hardware component, or the like. The general-purpose processor may be a microprocessor, any conventional processor, or the like.

The user interface 430 includes one or more output apparatuses 431 that enable presentation of media content, including one or more speakers and/or one or more visual display screens. The user interface 430 further includes one or more input apparatuses 432, including user interface components that facilitate user input, for example, a keyboard, a mouse, a microphone, a touch display screen, a camera, other input buttons and controls.

The memory 450 may be removable, non-removable, or a concatenation thereof. For example, a hardware device includes a solid-state memory, a hard disk drive, or an optical disk drive. In some embodiments, the memory 450 includes one or more storage devices physically located away from the processor 410.

The memory 450 may include a volatile memory or a non-volatile memory, or may include both the volatile memory and the non-volatile memory. The non-volatile memory may be a read-only memory (ROM), and the volatile memory may be a random-access memory (RAM). The memory 450 described in some embodiments is intended to include any suitable type of memory.

In some embodiments, the memory 450 can store data to support various operations, examples of the data include programs, modules, data structures, or subsets or supersets of the data. Examples are described below.

An operating system 451 includes system programs for handling various system services and performing hardware-related tasks, for example, a frame layer, a core library layer, and a drive layer, and is configured for implementing various services and processing hardware-based tasks.

A network communication module 452 is configured to reach another electronic device through one or more (wired or wireless) network interfaces 420. For example, the network interface 420 includes: Bluetooth, wireless fidelity (Wi-Fi), a universal serial bus (USB), and the like.

A presentation module 453 is configured to enable presentation of information through one or more output apparatuses 431 (for example, display screens and speakers) associated with the user interface 430 (for example, a user interface configured to operate a peripheral device and display content and information).

An input processing module 454 is configured to detect one or more user inputs or interactions from one or more input apparatuses 432 and translate the detected inputs or interactions.

In some embodiments, the apparatus provided in some embodiments may be implemented by software. FIG. 3 shows an information recommendation apparatus 455 stored in the memory 450. The information recommendation apparatus 455 may be software in a form of a program, a plug-in and the like, and includes the following software modules: a first obtaining module 4551, a first feature extraction module 4552, a first determining module 4553, and a sending module 4554. The modules are logical, and therefore may be combined in any manner or further split based on implemented functions. The following describes functions of the modules.

In some other embodiments, the apparatus provided in some embodiments may be implemented by hardware. As an example, the apparatus provided in some embodiments may be a processor in a form of a hardware decoding processor that is programmed to perform the information recommendation method provided in some embodiments. For example, the processor in the form of the hardware decoding processor may use one or more application integrated circuits (ASICs), DSPs, programmable logic devices (PLDs), complex programmable logic devices (CPLDs), field-programmable gate arrays (FPGAs), or other electronic elements.

In some embodiments, the server may implement the information recommendation method provided in some embodiments by running various computer-executable instructions or computer programs. For example, the computer-executable instructions may be microprogram-level commands, machine instructions, or software instructions. For example, the computer program may be an original program or a software module in an operating system, or may be a native application (APP), that is, a program that needs to be installed in the operating system to run, for example, a recommendation APP, or may be a mini program that can be embedded in any APP, that is, a program that only needs to be downloaded into a browser environment to run. In conclusion, the foregoing computer-executable instructions may be instructions in any form, and the foregoing computer program may be an application program, a module, or a plug-in in any form.

The information recommendation method provided in some embodiments is described with reference to exemplary application and implementation of the server provided in some embodiments.

The following describes the information recommendation method provided in some embodiments. As mentioned above, the computer device that implements the information recommendation method provided in some embodiments may be a terminal, a server, or a combination thereof. Therefore, execution entities of operations are not repeatedly described below.

In the following example of the information recommendation method, an example in which an object is an advertisement is used for description. A person skilled in the art may apply, based on an understanding of the following descriptions, the information recommendation method provided in some embodiments to recommendation of information about other types of objects, such as news reports, educational content, technology display content, and social media content. Some embodiments may further be applied to various scenarios, including, but not limited to, digital media, education and training, agriculture, instant messaging, artificial intelligence, intelligent transportation, and assisted driving.

FIG. 4 is a first schematic flowchart of an information recommendation method according to some embodiments. The information recommendation method provided in some embodiments is described with reference to operations shown in FIG. 4. In FIG. 4, an execution entity is a server.

Operation S101: Obtain first object data of a plurality of recommendation target objects and a plurality of pieces of to-be-recommended information.

In some embodiments, the first object data may be attribute data, historical data, or the like of the recommendation target object. For example, the first object data may include occupation, a public profile, public interaction data, public social data, and the like. The to-be-recommended information may be information, an item, a service, or content to be recommended. For example, the to-be-recommended information may be item information, service information, an advertisement, a news report, educational content, disaster warning information, a content work, or the like. The to-be-recommended information may include entity information and display information. An entity may be an item, a product, or the like. The entity information may be a specification, a function, a material, an appearance, or the like of the item, and the display information may be an advertisement, a demonstration video, a picture, or the like.

In some embodiments, the first object data of the plurality of recommendation target objects and the plurality of pieces of to-be-recommended information may be obtained from a publicly available database.

Operation S102: Separately perform feature extraction on the first object data and the to-be-recommended information by using a trained feature extraction model, to correspondingly obtain object features and information features.

In some embodiments, the trained feature extraction model is obtained by training a to-be-trained feature extraction model based on a plurality of training sample graphs and at least one training subgraph corresponding to each training sample graph, and the training subgraph is obtained by performing graph sampling on the training sample graph.

In some embodiments, the trained feature extraction model is a model that can perform feature extraction on a graph, and is usually a graph neural network (GNN). The GNNs are neural network models specially designed for processing graph-structured data. The GNNs extract features on a graph by learning a relationship between nodes, and are configured for prediction and classification tasks.

A idea of the GNNs is to pass information and update node representations by using a connection relationship (edge) between nodes. In the GNNs, each node has a feature vector that represents an attribute of the node. The GNNs may aggregate information about neighboring nodes by using weights of edges, and add the information to the feature vector of the current node. This process is referred to as message passing, and is a core mechanism of the GNNs.

The GNNs can capture complex relationships and patterns in graph-structured data through message passing, and therefore achieve excellent performance in many application scenarios, such as the fields of social network analysis, recommendation systems, knowledge graphs, and bioinformatics.

In some embodiments, a common graph neural network model includes a graph convolutional network, a graph autoencoder, a graph attention network, a graph recurrent neural network, a graph isomorphism network, a heterogeneous hypergraph network, and the like.

In some embodiments, feature extraction may be sequentially or simultaneously performed on the first object data and the to-be-recommended information by using the trained feature extraction model, to obtain an object feature corresponding to the first object data and an information feature corresponding to the to-be-recommended information.

In some embodiments, the trained feature extraction model is obtained through training based on training sample graphs and training subgraphs of the training sample graphs. In this way, self-supervised contrastive learning can be implemented based on the training sample graphs and the training subgraphs, so that the trained feature extraction model has features of high stability and strong robustness.

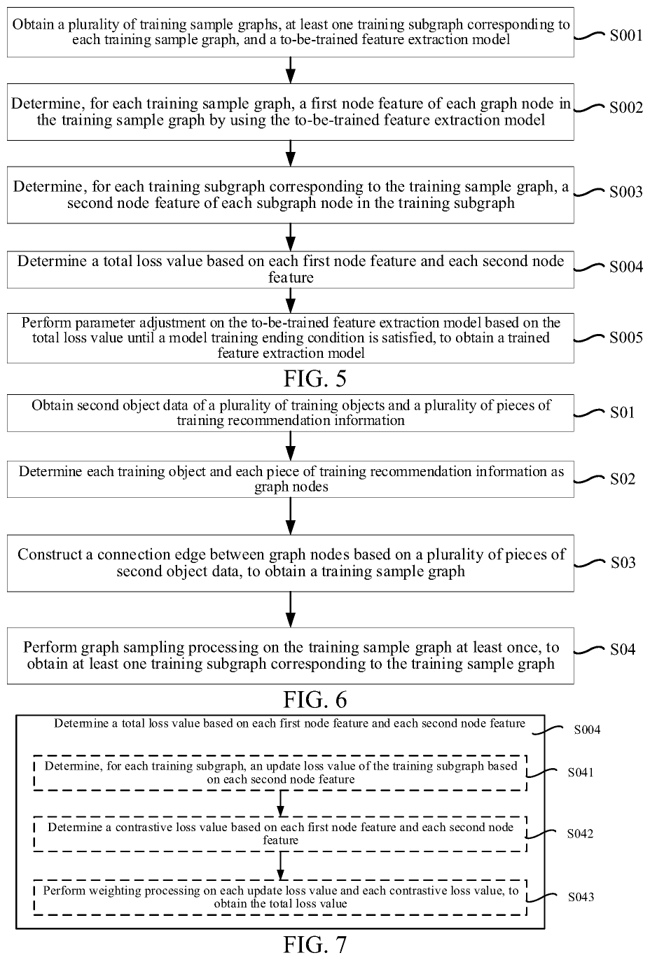

In some embodiments, before feature extraction is performed on the first object data and the to-be-recommended information, the trained feature extraction model may be obtained in a manner of self-supervised contrastive learning. In other words, before operation S102 is performed, refer to FIG. 5. The trained feature extraction model may further be obtained through the following operation S001 to operation S004, which are described below in detail.

Operation S001: Obtain a plurality of training sample graphs, at least one training subgraph corresponding to each training sample graph, and a to-be-trained feature extraction model.

In some embodiments, the training sample graph includes a plurality of graph nodes, and the training subgraph includes a plurality of subgraph nodes.

In some embodiments, the training sample graph may be a heterogeneous graph, or may be a homogeneous graph. The heterogeneous graph is a graph having different node types or edge types. For example, a social network graph includes different types of graph nodes such as users, posts, and topics, and different types of edges such as user-post publishing relationships and post-topic belonging relationships. A film and television network graph includes different types of graph nodes such as movies, actors, and directors. A recommendation network includes different types of graph nodes such as users, items, and advertisements.

In some embodiments, one training sample graph corresponds to at least one training subgraph. For example, a quantity of training subgraphs corresponding to one training sample graph may be two, three, four, or more. The training subgraph is obtained by performing graph sampling on the training sample graph. The training subgraph includes some graph nodes in the training sample graph. In other words, subgraph nodes of the training subgraph are included in graph nodes of the corresponding training sample graph.

In some embodiments, before the training sample graph and the at least one training subgraph corresponding to the training sample graph are obtained, the training sample graph and the training subgraph are constructed. Refer to FIG. 6. Before operation S001 is performed, the training sample graph and the training subgraph may further be constructed through the following operation S01 to operation S05, which are described below in detail.

Operation S01: Obtain second object data of a plurality of training objects and a plurality of pieces of training recommendation information.

In some embodiments, the training object may be a company employee, an association member, a school student, or the like. A matching relationship or an association relationship between the training objects and the training recommendation information is known. The second object data is similar to the first object data in operation S101. The second object data may be attribute data, historical data, or the like of the training object. For example, the second object data may include occupation, a public profile, public interaction data, public social data, and the like. The training recommendation information is similar to the to-be-recommended information in operation S101. The training recommendation information may be information, an item, a service, or content to be recommended. For example, the training recommendation information may be item information, service information, an advertisement, a news report, educational content, disaster warning information, a content work, or the like. The training recommendation information may include entity information and display information.

In some embodiments, the second object data of the plurality of training objects and the plurality of pieces of training recommendation information may be obtained from a publicly available database.

Operation S02: Determine each training object and each piece of training recommendation information as graph nodes.

In some embodiments, each training object and each piece of training recommendation information are respectively determined as graph nodes. For example, assuming that there are five training objects and 10 pieces of training recommendation information, 15 graph nodes are determined, and each graph node corresponds to a training object or a piece of training recommendation information.

Operation S03: Construct a connection edge between the graph nodes based on a plurality of pieces of second object data, to obtain a training sample graph.

In some embodiments, whether an association relationship exists between a training object and each piece of training recommendation information is determined based on the second object data. If it is determined that an association relationship exists between the training object and a piece of training recommendation information, a connection edge is constructed between the two graph nodes; and if it is determined that no association relationship exists between the training object and the piece of training recommendation information, it is determined that no connection edge exists between the two graph nodes, and no connection edge is constructed between the two graph nodes. In this way, a training sample graph including the plurality of training objects and the plurality of pieces of training recommendation information are obtained.

One of the training objects is used as an example. It is assumed that second object data of the training object indicates that the training object is a primary school teacher, and 10 pieces of training recommendation information are respectively a car, a car advertisement, a cup advertisement, a toy advertisement, a primary school textbook, a primary school textbook advertisement, a primary school popular science report, a decoration advertisement, college entrance examination information, and senior high school entrance examination information. Based on this, because associations exist between the primary school teacher and the primary school textbook, the primary school textbook advertisement, and the primary school popular science report, edges between a graph node corresponding to the training object and graph nodes corresponding to the primary school textbook, the primary school textbook advertisement, and the primary school popular science report are respectively constructed.

Operation S04: Perform graph sampling processing at least once on the training sample graph, to obtain at least one training subgraph corresponding to the training sample graph.

In some embodiments, a quantity of times of graph sampling is preset. One training subgraph may be obtained by performing graph sampling once. The quantity of times of graph sampling is consistent with a quantity of training subgraphs. For example, graph sampling may be performed twice, three times, four times, or more, and a quantity of obtained training subgraphs is equal to a quantity of times that graph sampling is performed.

In some embodiments, graph sampling may be performed on the training sample graph in any one of the following graph sampling manners, to obtain the at least one training subgraph corresponding to the training sample graph.
Graph sampling manner 1: Random walk sampling: Starting from an initial node, a random transition to another node in a graph is performed according to a probability distribution. The process may be repeated, so that a series of nodes is generated, and the nodes form a subgraph.
Graph sampling manner 2: Random edge sampling: An edge in a graph is directly randomly selected without considering a direction and a weight of the edge. Sampling may be performed with replacement or without replacement.
Graph sampling manner 3: Random node sampling. A node in a graph is randomly selected without considering a neighbor of the node. Sampling may be simple random sampling, sampling with replacement, or sampling without replacement.
Graph sampling manner 4: Structured random walks: A particular rule, for example, a transition probability or an order in which nodes are visited, is followed in a sampling process.
Graph sampling manner 5: Content-based random walks: Feature information of a node is considered in a walk process, and a visit probability of the node is determined based on the feature information. The manner is often configured for personalized recommendation, knowledge graph completion, and the like.
Graph sampling manner 6: Model-based random walks: A walk path is selected based on a predefined model, for example, a Markov-chain-based random walk. The manner is often configured for a graph generation model, a graph probability inference, and the like.
Graph sampling manner 7: Node clustering: A subgraph is created by grouping nodes. For example, a graph is partitioned into subgraphs by using a community detection algorithm (for example, Louvain or Girvan-Newman).

According to operation S01 to operation S04, the training sample graph can be quickly constructed based on the training object, the training recommendation information, and the second object data. In addition, the training subgraph corresponding to the training sample graph is efficiently generated through graph sampling, to provide data support for subsequent model training.

Still refer to FIG. 5. The following description continues from operation S001 described above.

Operation S002: Determine, for each training sample graph, a first node feature of each graph node in the training sample graph by using the to-be-trained feature extraction model.

In some embodiments, the training sample graph may be input to the to-be-trained feature extraction model, and feature extraction is performed on the training sample graph by using the to-be-trained feature extraction model, to obtain a first initial feature of each graph node in the training sample graph. Then, feature updating is performed on the first initial feature of each graph node, to obtain the first node feature of each graph node.

In some embodiments, the first initial feature is a feature of a graph node before graph updating. The feature of the graph node is a set of information associated with each graph node in a graph. The feature may describe a property or a state of the graph node or various attributes related to the graph node. In different application scenarios, the feature of the graph node may have different meanings and functions.

In some embodiments, the feature of the graph node may include the following types.
Type 1: attributes: The attributes include an identifier, a name, a type, and the like of a graph node. For example, in a social network, an identifier of a graph node may be a user identifier, and a type may be “user”. In a knowledge graph, a node may be an entity, such as a “person”, an “organization”, or a “location”, and each node has a corresponding unique identifier.
Type 2: Structural features: The structural features describe a position and a relationship of a graph node in a graph structure. For example, the structural features include a degree of a node (a quantity of connected edges), closeness (a shortest path length to the node), a clustering coefficient (a density of connections between neighbors of the node), and the like.
Type 3: Attribute features: If a graph node has particular attributes or attribute values, such as an age and a gender of a person, or a size and an industry of an organization, the attributes or attribute values may also be used as features of the node.
Type 4: Dynamic features: In some graphs, features of graph nodes may change over time, such as public behavior scores of users and stock prices.
Type 5: External features: In some cases, features of a graph node may be from an information source outside a graph, for example, based on information from an external knowledge base, such as a category or an attribute of an entity in the knowledge graph.

In a graph processing model, for example, a graph neural network, a feature of a node is crucial for a model to understand and predict a pattern in a graph. GNNs capture a structure of the graph and a relationship between nodes by learning feature representations of the nodes, and are configured for various graph analysis tasks, such as recommendation, node classification, link prediction, and community detection.

In some embodiments, the first initial feature may be generated in the following two manners.

Manner 1: A first initial feature of each graph node in the training sample graph is randomly generated based on a preset dimension by using the to-be-trained feature extraction model.

In some embodiments, the preset dimension is a dimension set in advance. For example, the preset dimension may be 1×5, 2×6, or the like.

In some embodiments, according to principles such as a normal distribution and a 0-1 random distribution, a first initial feature in the preset dimension may be randomly generated based on object data by using the to-be-trained feature extraction model. The first initial feature corresponds to a graph node in the training sample graph.

Manner 2: When the second object data includes object data in at least two dimensions, feature extraction is separately performed on object data in different dimensions by using the to-be-trained feature extraction model, to obtain dimension object features in the different dimensions. The dimension object features are concatenated, to obtain a first initial feature of a graph node corresponding to a training object. When the training recommendation information includes recommendation information in at least two dimensions, feature extraction is separately performed on recommendation information in different dimensions, to obtain dimension information features in the different dimensions. The dimension information features are concatenated, to obtain a first initial feature of a graph node corresponding to the training recommendation information.

In some embodiments, the first initial feature may be obtained through feature concatenation. For example, when the second object data includes occupation data and public interaction data, feature extraction is separately performed on the occupation data and the public interaction data, to obtain occupation feature data and interaction feature data. The occupation feature data and the interaction feature data are then concatenated in a manner in which the occupation feature data is placed before the interaction feature data, to obtain a first initial feature of a graph node corresponding to the training object.

For example, when the training recommendation information includes description information, performance information, and technical information, feature extraction is separately performed on the description information, the performance information, and the technical information, to obtain description feature data, performance feature data, and technical feature data. The description feature data, the performance feature data, and the technical feature data are then concatenated in an order of the description feature data, the performance feature data, and the technical feature data, to obtain a first initial feature of a graph node corresponding to the training recommendation information.

In some embodiments, a first initial feature may be quickly obtained in Manner 1, thereby improving processing efficiency. However, in Manner 2, a first initial feature with high accuracy can be obtained, so that a quantity of times that a model is subsequently trained can be reduced, thereby enabling the model to converge quickly.

In some embodiments, when feature updating is performed on the first initial feature of the graph node, to obtain a first node feature of the graph node, a neighboring node of the graph node may be first obtained from the training sample graph based on a connection relationship between nodes. The neighboring node is a node having a connection edge with the graph node. Then, fusion processing is performed on the first initial feature of the graph node and a first initial feature of the neighboring node of the graph node, to obtain the first node feature of the graph node.

Different types of to-be-trained feature extraction models correspond to different feature updating manners. An example in which the to-be-trained feature extraction model is a graph attention network is used. Features of neighboring nodes are aggregated by using adaptive weights, to update a first initial feature of a graph node in a training sample graph, so as to obtain a first node feature of the graph node. A core idea of the graph attention network is to calculate an attention coefficient for each graph node in the training sample graph, to determine importance between a graph node and a neighboring node of the graph node; and perform fusion processing on first initial features of the graph node and the neighboring node based on the coefficient, to obtain a first node feature.

In some embodiments, a process of updating the first initial feature by using the graph attention network includes attention mechanism determining, weighted feature aggregation, multi-head attention, and iterative application. An attention mechanism determining process includes: for each graph node, first determining an attention coefficient, where the attention coefficient measures a degree of association between the graph node and the neighboring node of the graph node. The attention coefficient is usually determined through a feedforward network called an “attention head”. The feedforward network includes two linear transformations: a non-linear activation function (for example, ReLU) and a dropout (Dropout) layer, to improve the robustness of a model. For a weighted feature aggregation process, features of neighboring nodes are aggregated in a weighted averaging manner, and a weight is an attention coefficient determined by using an attention mechanism. For a multi-head attention process, a multi-head attention mechanism is used, in other words, a plurality of attention heads are run in parallel, and each head calculates a group of attention coefficients and performs feature aggregation. Finally, first node features outputted by all the heads are concatenated, and an updated first node feature is obtained through a linear transformation and a final activation function. For an iterative application process, the foregoing process is repeatedly applied to each node in the graph, and the first node feature is updated in each iteration. Through a quantity of iterations, the model may learn a higher-level feature representation of a subgraph node in the training subgraph.

In some embodiments, the graph attention network may further learn of different types of neighbor relationships by adjusting the attention coefficient, thereby improving adaptability and flexibility of the model.

Fusion processing is performed on the first initial feature of the graph node and the first initial feature of the neighboring node of the graph node, to perform feature updating on the graph node and obtain the first node feature of the graph node. In this way, the graph node can perceive local topological structure information of the graph node, to more comprehensively represent a role of the graph node in a graph, thereby enhancing a feature representation capability of the first node feature, and improving robustness of feature representation.

Operation S003: Determine, for each training subgraph corresponding to the training sample graph, a second node feature of each subgraph node in the training subgraph.

In some embodiments, the “determining a second node feature of each subgraph node in the training subgraph” in operation S003 may be implemented through the following operation S031 and operation S032, which are described below in detail.

Operation S031: Determine, as a second initial feature of a subgraph node, a first initial feature of a target graph node that is in the training sample graph and that corresponds to the subgraph node in the training subgraph.

In some embodiments, because subgraph nodes of a training subgraph are included in graph nodes of a corresponding training sample graph, first initial features of the graph nodes include a second initial feature of each subgraph node. A target graph node corresponding to a subgraph node may be determined based on a node identifier of the subgraph node, and then a first initial feature of the target graph node is determined as a second initial feature of the subgraph node.

Operation S032: Perform feature updating on each second initial feature, to obtain a second node feature of each subgraph node.

In some embodiments, different types of to-be-trained feature extraction models correspond to different updating manners. An example in which the to-be-trained feature extraction model is a graph attention network is used. Features of neighboring nodes are aggregated by using adaptive weights, to update a second initial feature of a subgraph node in a training subgraph, so as to obtain a second node feature of the subgraph node. A core idea of the graph attention network is to calculate an attention coefficient for each training subgraph node, to determine importance between a training subgraph node and a neighboring node of the training subgraph node; and aggregate features of neighboring nodes based on coefficients.

In some embodiments, a process of updating the second initial feature by using the graph attention network includes attention mechanism determining, weighted feature aggregation, multi-head attention, and iterative application. An attention mechanism determining process includes: for each training subgraph node, first determining an attention coefficient, where the attention coefficient measures a degree of association between the training subgraph node and the neighboring node of the training subgraph node. The attention coefficient is usually determined through a feedforward network called an “attention head”. The feedforward network includes two linear transformations: a non-linear activation function (for example, ReLU) and a dropout (Dropout) layer, to improve the robustness of a model. For a weighted feature aggregation process, features of neighboring nodes are aggregated in a weighted averaging manner, and a weight is an attention coefficient determined by using an attention mechanism. For a multi-head attention process, a multi-head attention mechanism is used, in other words, a plurality of attention heads are run in parallel, and each head calculates a group of attention coefficients and performs feature aggregation. Finally, second node features outputted by all the heads are concatenated, and an updated second node feature is obtained through a linear transformation and a final activation function. For an iterative application process, the foregoing process is repeatedly applied to each node in the graph, and the second node feature is updated in each iteration. Through a quantity of iterations, the model may learn a higher-level feature representation of a subgraph node in the training subgraph.

In some embodiments, the graph attention network may further learn of different types of neighbor relationships by adjusting the attention coefficient, thereby improving adaptability and flexibility of the model.

In a model training process, the second initial feature is first updated, to obtain a second node feature. Then, the second node feature is updated to obtain an updated second node feature.

According to operation S031 and operation S032, local structure information in the subgraph can be captured, and representations of training subgraph nodes can be effectively learned.

Still refer to FIG. 5. The following description continues from operation S003 described above.

Operation S004: Determine a total loss value based on each first node feature and each second node feature.

In some embodiments, for each training subgraph, an update loss value is determined based on a second node feature of each subgraph node in the training subgraph. In addition, a contrastive loss value is further determined based on a first node feature of each graph node in the training sample graph and the second node feature of each subgraph node in the training subgraph. In this way, the update loss value of each training subgraph and the contrastive loss value between the training sample graph and each training subgraph are determined. Finally, the total loss value is determined based on each update loss value and each contrastive loss value.

In some embodiments, refer to FIG. 7. Operation S004 may be implemented through the following operation S041 to operation S043, which are described below in detail.

Operation S041: Determine, for each training subgraph, an update loss value of the training subgraph based on each second node feature.

In some embodiments, the update loss value may be determined by using any one of a cross-entropy loss function, a Bayesian personalized ranking loss function, and a margin loss function. The update loss value is used to constrain a first connection score between a subgraph node u and a subgraph node v to be higher than a second connection score between the subgraph node u and any noise.

In some embodiments, operation S041 may be implemented through the following operation S411 to operation S413, which are described below in detail.

Operation S411: Determine a first connection score between a u^{th} subgraph node and a v^{th} subgraph node based on a second node feature of the u^{th} subgraph node and a second node feature of the v^{th} subgraph node.

In some embodiments, u=1, 2, . . . , N, v=1, 2, . . . , N, u is not equal to v, and N is a total quantity of subgraph nodes included in the training subgraph.

In some embodiments, the first connection score between the u^{th} subgraph node and the v^{th} subgraph node may be determined based on the second node feature of the u^{th} subgraph node and the second node feature of the v^{th} subgraph node by using a feedforward network. In some embodiments, a classifier (such as logistic regression or a multilayer perceptron) may be used to determine the first connection score between the u^{th} subgraph node and the v^{th} subgraph node. The first connection score is configured for representing a probability that a connection edge exists between the u^{th} node and the v^{th} node.

Operation S412: Obtain k noise distributions, and determine a second connection score between the u^{th} node and a noise node based on the second node feature of the u^{th} node and the noise distribution.

In some embodiments, during implementation of operation S412, sampling is first performed, based on the noise distributions, on subgraph nodes included in the training subgraph, to obtain noise nodes corresponding to the noise distributions. Then, the second connection score between the u^{th} node and the noise node is determined based on the second node feature of the u^{th} node and a second node feature of the noise node. For a process of determining the second connection score, refer to the foregoing process of determining the first connection score. In this way, k second connection scores between the u^{th} node and k noise nodes are respectively determined. The second connection score is configured for representing a probability that a connection edge exists between the u^{th} node and the noise node.

In some embodiments, the noise distribution is an arbitrary distribution. For example, the noise distribution may be a uniform distribution. In this case, sampling is performed, based on the noise distributions, on subgraph nodes included in the training subgraph, to obtain noise nodes corresponding to the noise distributions. During implementation, uniform sampling may be performed from a subgraph node that has no connection edge with the u^{th} node and that is in the training subgraph, to obtain a noise node. The noise distribution may be a degree-based distribution, in other words, a probability that a node is sampled is proportional to a degree of the node. In this case, sampling probabilities of subgraph nodes may be determined based on a degree of a subgraph node that has no connection edge with the u^{th} node and that is in the training subgraph, and then sampling is performed based on the sampling probabilities of the subgraph nodes, to obtain the noise nodes. The noise node is a subgraph node unrelated to the u^{th} node (in other words, no connection edge exists between the subgraph node and the u^{th} node), and is configured for constructing a negative pair with the u^{th} node. The to-be-trained feature extraction model is trained by using the negative pairs, so that a capability of the model to capture a real graph structure model can be improved.

Operation S413: Determine an update loss value based on the first connection score and the second connection score.

In some embodiments, using the cross-entropy loss function as an example, the update loss value may be determined according to the following formula (1).

L_{edge}=−log σ(first connection score)−Σ_{i=1, . . . ,k} log[1−σ(second connection score)ᵢ] Formula (1).

In Formula (1), L_{edge} represents the update loss value, and a is an activation function.

According to operation S411 to operation S413, the update loss value of each training subgraph can be determined, and noise is processed in the determining process. Therefore, the update loss value can correctly guide a training direction of the to-be-trained feature extraction model.

Still refer to FIG. 7. The following description continues from operation S041 described above.

Operation S042: Determine a contrastive loss value based on each first node feature and each second node feature.

In some embodiments, the to-be-trained feature extraction model is trained in a self-supervised manner by using the training sample graph, and a contrastive loss value is further introduced based on the first node feature and the second node feature. In some embodiments, the contrastive loss value may be determined by using any one of an information noise contrastive estimation (InfoNCE) loss function, a two-tower loss function, a triplet contrastive loss function, a pairwise contrastive loss function, and a non-parameter contrastive loss function.

In some embodiments, operation S042 may be implemented through the following operation S421 to operation S423, which are described below in detail.

Operation S421: Determine a third similarity between an i^{th} graph node and an i^{th} subgraph node based on a first node feature of the i^{th} graph node and a second node feature of the i^{th} subgraph node.

In some embodiments, i=1, 2, . . . , M, and M is a total quantity of graph nodes included in the training sample graph.

In some embodiments, an implementation process of determining the third similarity may be one of the following implementation processes.
Implementation process 1: Euclidean distance: For the first node feature and the second node feature that are of numerical types, the Euclidean distance may be used to determine the third similarity between the i^{th} graph node and the i^{th} subgraph node. A smaller distance indicates a higher similarity between the first node feature of the i^{th} graph node and the second node feature of the i^{th} subgraph node.
Implementation process 2: Manhattan distance The Manhattan distance is similar to the Euclidean distance, but considers a sum of absolute differences of features in respective dimensions.
Implementation process 3: Cosine similarity: For a first node feature and a second node feature in high-dimensional space, the cosine similarity is an effective metric. The cosine similarity measures a cosine value of an included angle between the first node feature of the i^{th} graph node and the second node feature of the i^{th} subgraph node. A larger value indicates a higher similarity between the first node feature of the i^{th} graph node and the second node feature of the i^{th} subgraph node.
Implementation process 4: Pearson correlation coefficient: The Pearson correlation coefficient is configured for determining a strength of a linear relationship between the first node feature of the i^{th} graph node and the second node feature of the i^{th} subgraph node. A value ranges from −1 to 1, where 1 indicates a complete positive correlation, −1 indicates a complete negative correlation, and 0 indicates no correlation.
Implementation process 5: Hamming distance: The Hamming distance is configured for determining a difference between the first node feature of the i^{th} graph node and the second node feature of the i^{th} subgraph node, that is, a quantity of different bits. A smaller value indicates a higher similarity between the first node feature of the i^{th} graph node and the second node feature of the i^{th} subgraph node.
Implementation process 6: Euclidean normalization: The first node feature of the i^{th} graph node and the second node feature of the i^{th} subgraph node are normalized, so that the features are scaled to a particular range, and then a Euclidean distance or a correlation coefficient is determined.
Implementation process 7: Cosine similarity normalization: The cosine similarity normalization is similar to Euclidean normalization, but a cosine similarity is configured for measuring the third similarity between the first node feature of the i^{th} graph node and the second node feature of the i^{th} subgraph node.

In some embodiments, if the i^{th} subgraph node does not exist in the training subgraph, the second node feature of the i^{th} subgraph node is 0.

Operation S422: Determine a fourth similarity between the i^{th} graph node and a k^{th} subgraph node based on the first node feature of the i^{th} graph node and a second node feature of the k^{th} subgraph node.

In some embodiments, i=1, 2, . . . , M, k=1, 2, . . . , N, and k is not equal to i.

In some embodiments, an implementation process of operation S422 is similar to the implementation process of operation S421. Therefore, for the implementation process of operation S422, refer to the implementation process of operation S421.

Operation S423: Determine a contrastive loss value based on the third similarity and the fourth similarity.

In some embodiments, using an example in which the contrastive loss value is determined by using an information noise contrastive estimation loss function, the contrastive loss value may be determined according to Formula (2).

$${L}_{InfoNCE} = - log ( \frac{exp ( third similarity / τ )}{{\sum }_{k = 1}^{N} {1}_{[ k \neq i ]} exp ( {( fourth similarity )}_{k} / τ )} ) . \qquad Formula ( 2 )$$

In Formula (2), L_{InfoNCE} represents the contrastive loss value, τ is a temperature coefficient, and N is a quantity of subgraph nodes of the training subgraph. 1_{[k≠i]} indicates that a value is 1 when k≠i, and is otherwise 0.

According to operation S421 to operation S423, the contrastive loss value is determined based on the first node feature of the training sample graph and the second node feature of the training subgraph. In this way, self-supervised contrastive learning is introduced in a process of determining the contrastive loss value, thereby improving a training speed of the to-be-trained feature extraction model, ensuring correctness of a learning direction of the to-be-trained feature extraction model, and obtaining a trained feature extraction model with high stability and strong robustness.

Still refer to FIG. 7. The following description continues from operation S042 described above.

Operation S043: Perform weighting processing on each update loss value and each contrastive loss value, to obtain a total loss value.

In some embodiments, each update loss value and each contrastive loss value may be directly accumulated to obtain the total loss value. In some embodiments, each update loss value and each contrastive loss value may first be respectively multiplied by corresponding preset weight values, to correspondingly obtain a weighted update loss value and a weighted contrastive loss value, and then each weighted update loss value and each weighted contrastive loss value are accumulated to obtain the total loss value.

According to operation S041 to operation S043, the update loss value is determined based on the second node feature of the training subgraph, the contrastive loss value is further determined based on the first node feature of the training sample graph and the second node feature of the training subgraph, and finally, the total loss value is determined based on the update loss value and the contrastive loss value. In a process of determining the update loss value, noise is processed, so that a training direction of the to-be-trained feature extraction model can be correctly guided. In addition, in a process of determining the contrastive loss value, self-supervised contrastive learning is introduced, thereby improving a training speed of the to-be-trained feature extraction model, ensuring correctness of a learning direction of the to-be-trained feature extraction model, and finally obtaining a trained feature extraction model with high stability and strong robustness.

Still refer to FIG. 5. The following description continues from operation S004 described above.

Operation S005: Perform parameter adjustment on the to-be-trained feature extraction model based on the total loss value until a model training ending condition is satisfied, to obtain a trained feature extraction model.

In some embodiments, the model training ending condition may be that a quantity of times of training reaches a quantity threshold, or the model training ending condition may be that a total loss value is less than a loss threshold.

When the model training ending condition is not satisfied, a parameter of the to-be-trained feature extraction model is adjusted based on the total loss value; and when the model training ending condition is satisfied, it is considered that the trained feature extraction model is obtained.

According to operation S001 to operation S005, in the training process of the to-be-trained feature extraction model, the update loss value of the training subgraph and the contrastive loss value between the training sample graph and the training subgraph are introduced. In this way, ideas of self-supervision and contrastive learning are introduced to the model training process, thereby improving a training speed of the to-be-trained feature extraction model, ensuring correctness of a learning direction of the to-be-trained feature extraction model, and finally obtaining a trained feature extraction model with high accuracy, high stability, and strong robustness.

Still refer to FIG. 4. The following description continues from operation S102 described above.

Operation S103: Determine, based on the plurality of object features and the plurality of information features, target to-be-recommended information matching each recommendation target object.

In some embodiments, the target to-be-recommended information matching each recommendation target object is determined from the plurality of pieces of to-be-recommended information. The target to-be-recommended information may be considered as recommendation information in which the recommendation target object is interested or that is needed by the recommendation target object.

In some embodiments, from a perspective of a recommendation target object, for each recommendation target object, the target to-be-recommended information matching the recommendation target object is determined from the plurality of pieces of to-be-recommended information through screening based on an object feature of the recommendation target object and the plurality of information features.

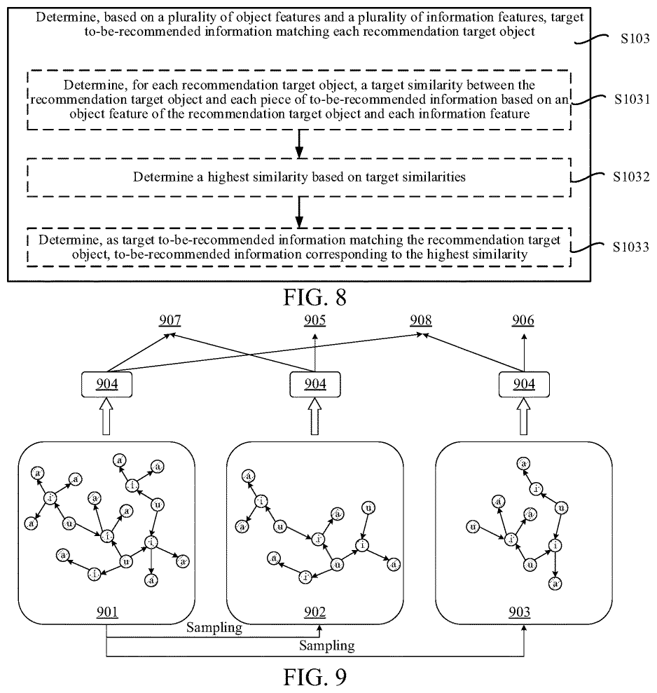

In some embodiments, refer to FIG. 8. Operation S103 may be implemented through the following operation S1031 to operation S1033, which are described below in detail.

Operation S1031: Determine, for each recommendation target object, a target similarity between the recommendation target object and each piece of to-be-recommended information based on an object feature of the recommendation target object and each information feature.

In some embodiments, when the plurality of pieces of to-be-recommended information include at least one piece of to-be-recommended entity information and at least one piece of to-be-recommended display information, the information feature is an entity feature or a display feature, and the target similarity is a first similarity between the recommendation target object and the to-be-recommended entity information, or a second similarity between the recommendation target object and the to-be-recommended display information. Based on this, operation S1031 may be implemented through the following operation S0311 to operation S0313, which are described below in detail.

Operation S0311: Determine a first similarity between the recommendation target object and each piece of the to-be-recommended entity information based on the object feature and each entity feature.

In some embodiments, the to-be-recommended entity information may be item information, organization information, location information, or the like, and the to-be-recommended display information may be advertisement information, news information, alarm information, or the like.

In some embodiments, the first similarity between the recommendation target object and each piece of to-be-recommended entity information may be obtained by performing a dot product operation on the object feature and each entity feature.

In some embodiments, the first similarity between the recommendation target object and each piece of the to-be-recommended entity information may be determined based on the object feature and each entity feature in manners such as a Euclidean distance, a Manhattan distance, or a cosine similarity.

In some embodiments, the first similarity can reflect a degree of matching between the recommendation target object and a to-be-recommended entity, can also reflect a correlation between the recommendation target object and the to-be-recommended entity, and may further reflect a degree of interest of the recommendation target object in the to-be-recommended entity. A larger first similarity indicates a higher degree of matching between the recommendation target object and the to-be-recommended entity, a stronger correlation between the recommendation target object and the to-be-recommended entity, and a greater degree of interest of the recommendation target object in the to-be-recommended entity.

Operation S0312: Determine, based on each first similarity, a target to-be-recommended entity matching the recommendation target object.

In some embodiments, first similarities may be sorted in descending order, to obtain sorted first similarities, and then a to-be-recommended entity corresponding to the 1^{st} first similarity in the sorted first similarities is determined as the target to-be-recommended entity. In other words, the to-be-recommended entity corresponding to the highest first similarity is determined as the target to-be-recommended entity. The target to-be-recommended entity is a to-be-recommended entity matching the recommendation target object, and the target to-be-recommended entity is also a to-be-recommended entity in which the recommendation target object is interested.

Operation S0313: Determine a second similarity between the recommendation target object and each piece of the to-be-recommended display information based on an entity feature of the target to-be-recommended entity and a display feature of each piece of the to-be-recommended display information.

In some embodiments, a dot product result of the entity feature and the display feature may be determined as the second similarity. The second similarity can reflect a degree of matching between the target to-be-recommended entity and the to-be-recommended display information, and can also reflect a correlation between the target to-be-recommended entity and the to-be-recommended display information.

According to operation S0311 to operation S0313, when the plurality of pieces of to-be-recommended information include at least one piece of to-be-recommended entity information and at least one piece of to-be-recommended display information, the first similarity between the recommendation target object and each piece of to-be-recommended entity information is first determined, a target to-be-recommended entity matching the recommendation target object is then determined based on the first similarity, and the second similarity between the target to-be-recommended entity and each piece of to-be-recommended display information is further determined. In this way, the target similarity between the recommendation target object and each piece of to-be-recommended information is obtained.

In some embodiments, when all of the plurality of pieces of to-be-recommended information are to-be-recommended display information, the information features are display features. Based on this, operation S1031 may be implemented as follows: separately performing a dot product operation on the object feature and each information feature, to obtain the target similarity between the recommendation target object and each piece of to-be-recommended information.

When all of the plurality of pieces of to-be-recommended information are to-be-recommended display information, the dot product operation may be directly performed on the object feature and each information feature, to quickly obtain the target similarity between the recommendation target object and each piece of to-be-recommended information.

Still refer to FIG. 8. The following description continues from operation S1031 described above.

Operation S1032: Determine a highest similarity based on each target similarity.

In some embodiments, when operation S0311 to operation S0313 are used to determine a similarity, the highest similarity is determined from each second similarity. In other words, the largest value in the second similarities is determined as the highest similarity. During actual implementation, the second similarities may be sorted in descending order, and then the 1^{st} second similarity in the sorted second similarities is determined as the highest similarity.

When a target similarity between the recommendation target object and each piece of to-be-recommended information is obtained by directly performing the dot product operation on the object feature and each information feature, the highest similarity is determined from target similarities, in other words, the largest value in the target similarities is determined as the highest similarity.

Operation S1033: Determine, as target to-be-recommended information matching the recommendation target object, to-be-recommended information corresponding to the highest similarity.

According to operation S1031 to operation S1033, a similarity between the recommendation target object and each piece of to-be-recommended information may be first determined, and to-be-recommended information corresponding to the highest similarity is then determined as the target to-be-recommended information. In this way, the target to-be-recommended information matching the recommendation target object can be conveniently and efficiently determined from the plurality of pieces of to-be-recommended information.

Still refer to FIG. 4. The following description continues from operation S103 described above.

Operation S104: Send corresponding target to-be-recommended information to a terminal of each recommendation target object.

In some embodiments, a destination for delivering the target to-be-recommended information may be first determined. The destination may be a browser installed on a terminal of the recommendation target object, or may be an application program installed on the terminal of the recommendation target object. Then, a display form of the target to-be-recommended information is converted into a display form matching the delivery destination. Finally, the converted target to-be-recommended information is sent to the terminal of the recommendation target object, so that the terminal of the recommendation target object displays the target to-be-recommended information, in other words, the target to-be-recommended information is recommended to the recommendation target object through the terminal.

According to operation S101 to operation S104, the trained feature extraction model for feature extraction is obtained through training based on a plurality of training sample graphs and at least one training subgraph corresponding to each of the training sample graphs rather than being obtained through training based only on the plurality of training sample graphs, and the training subgraph is obtained by performing graph sampling on the training sample graph. In this way, self-supervised contrastive learning can be implemented based on the training sample graphs and the training subgraphs, in other words, the trained feature extraction model can be obtained in a self-supervised contrastive learning manner. In addition, in a model training process, noise is further processed by using an update loss value, thereby improving stability and robustness of the trained feature extraction model. Based on this, when feature extraction is performed on the first object data and the to-be-recommended information by using the trained feature extraction model, object features and information features with controllable quality can be obtained, in other words, object features and information features with high reliability, high accuracy, and generalization capabilities can be obtained. Therefore, target to-be-recommended information with a high matching degree and high accuracy can be determined based on the object features and the information features with high reliability, high accuracy, and generalization capabilities, thereby improving recommendation accuracy, improving a click-through rate and a conversion rate of the recommendation information, and further improving user stickiness of a recommendation system.

The following describes exemplary application of some embodiments in an actual application scenario.

Some embodiments provides an information recommendation method, including a training process of a to-be-trained feature extraction model. The training process may also be referred to as a contrastive-learning-based pre-training process of an embedding representation graph neural network. The pre-training process is configured for providing pre-trained feature representations of users, advertisements, or items for a recommendation system or an advertisement system. Relationships between “users, advertisements, and items” are fully learned and mined through graph neural network pre-training. More stable and more robust feature representation is obtained through contrastive learning. The feature representation corresponds to the first node feature or the second node feature in other embodiments. The feature representation obtained through pre-training on a large-scale heterogeneous graph may be used in various stages of the recommendation system, including user-to-item (U2I) retrieval, user-to-item-to-item (U2I2I) retrieval, click-through rate prediction, conversion rate prediction, and the like.

In some embodiments, a self-supervised loss and contrastive learning are introduced, so that quality of a learned feature representation is controllable, in other words, the feature representation with high effectiveness and accuracy is learned. In some embodiments, self-supervised contrastive learning is further performed, so that the learned feature representation is robust, generalizable, and stable.

Some embodiments can be applied to modules of the advertisement system and the recommendation system, for example, can be configured for pre-training learning for U2I retrieval, U2I2I retrieval, click-through rate prediction, and conversion rate prediction, so that the representation obtained through learning is used as a feature.

FIG. 9 is a schematic diagram of an implementation framework of a network structure according to some embodiments. First, a heterogeneous graph G 901 of “user-item-advertisement” is constructed based on data, and may be denoted as an original graph G. Next, random walks are performed based on the original graph G, to obtain two sampled subgraphs G1 902 and G2 903, in other words, the subgraph G1 902 and the subgraph G2 903 are obtained through graph sampling. A graph attention network 904 is used in each of the three graphs for feature propagation and updating. Edge prediction task training is separately performed on two sampled subgraphs G1 902 and G2 903, to obtain an update loss value 905 and an update loss value 906. In addition, contrastive learning is separately performed between the subgraph G1 902 and the original graph G, and between the subgraph G2 903 and the original graph G, to obtain a contrastive loss value 907 and a contrastive loss value 908. The original graph G corresponds to a training sample graph in other embodiments, and the subgraph G1 and the subgraph G2 correspond to training subgraphs in other embodiments. Finally, a node feature of the original graph G is used as a final feature representation, and the node feature of the original graph G corresponds to a first node feature in other embodiments.

In some embodiments, the method provided in some embodiments includes graph construction, graph updating, and loss function determining.

The graph construction includes construction of the original graph G and construction of subgraphs. First, a heterogeneous graph of “user-item-advertisement” is constructed based on data. An action of a user on an item is mined from the data, for example, the user placed an order for the item, and the action is used as an edge between the user and the item. An item associated with content of an advertisement is used as an edge between the advertisement and the item. Initial feature values of a user node, an item node, and an advertisement node may be random, or may be obtained by concatenating corresponding features. The initial feature value corresponds to the first initial feature in other embodiments.

After the original graph G is obtained (in other words, the heterogeneous graph G is obtained), two random walks are performed on the graph, to obtain sampled subgraphs G1 and G2. The subgraph G1 and the subgraph G2 are subgraphs of the original graph G.

In some embodiments, a GAT is used as an example to describe a graph updating process. The original graph G, the sampled subgraph G1, and the sampled subgraph G2 are each updated through a GAT network. The GAT introduces a self-attention mechanism in a propagation process, and a hidden state of each node is calculated by attending to a neighboring node of the node. The GAT is implemented by stacking simple graph attention layers. In each attention layer, for a node pair (i,j), a calculation manner of an attention coefficient is shown in Formula (3).

$${α}_{ij} = \frac{exp ( LeakyReLU ( {a}^{T} [ W {h}_{i} ‖ W {h}_{j} ] ) )}{{\sum }_{k ∈ {N}_{i}} exp ( LeakyReLU ( {a}^{T} [ W {h}_{i} ‖ W {h}_{k} ] ) )} . \qquad Formula ( 3 )$$

In Formula (3), αᵢⱼ is an attention coefficient from a node i to a node j. Nᵢ represents a neighboring node of the node i. An input node feature (that is, a feature before updating) is h={h₁, h₂, . . . , h_{N}}, where hᵢ∈R^{F}, and N represents a quantity of nodes, and F represents a feature dimension. W∈R^{F′×F} is a linear transformation weight matrix applied on each node. a∈R^{2Fr}′ is a weight vector, and may be configured for mapping an input feature to a real number R. Finally, normalization is performed by using softmax, and LeakyReLU is introduced to provide nonlinearity, where a slope for a negative input is 0.2.

In some embodiments, an output node feature (that is, an updated feature) may be denoted as h′={h′₁, h′₂, . . . , h′_{N}}, where h′ᵢ∈R^{F}′. The updated node feature may be obtained by using Formula (4).

h′ᵢ=σ(Σ_{j∈N}_{ᵢ}αᵢⱼWhⱼ) Formula (4).

In Formula (4), αᵢⱼ is obtained by using Formula (3).

In some embodiments, considering that multi-head attention can stabilize a learning process, hidden states are calculated by using multi-head attention in each attention layer and using K independent attention mechanisms, and features of the hidden states are then concatenated, to obtain an updated node feature. An output representation form is shown in Formula (5). In some embodiments, the updated node feature may be obtained by calculating an average value, and an output representation form is shown in Formula (6).

$${h}_{i}^{′} = {‖}_{k = 1}^{K} σ ( {\sum }_{j ϵ {N}_{i}} {α}_{ij}^{k} {W}^{k} {h}_{j} ) . \qquad Formula ( 5 )$$

In Formula (5),

$${α}_{ij}^{k}$$

is a normalized attention coefficient of a k^{th} attention head, K represents a quantity of attention heads, W^{k} is a linear transformation weight matrix of the k^{th} attention head, and ∥ represents a concatenation operation.

$${h}_{i}^{′} = σ ( \frac{1}{K} {\sum }_{k = 1}^{K} {\sum }_{j ∈ {N}_{i}} {α}_{ij}^{k} {W}^{k} {h}_{j} ) . \qquad Formula ( 6 )$$

In formula (6),

$${α}_{ij}^{k}$$

is a normalized attention coefficient of a k^{th} attention head, K represents a quantity of attention heads, and W^{k} is a linear transformation weight matrix of the k^{th} attention head.

A model type and a topology structure of a prediction network are not limited in some embodiments, and the foregoing GAT may be replaced with another model structure. For example, the another model structure may be a GCN, a GraphSage, or the like. In other words, graph representation updating may be performed by using the GCN and the GraphSage. In some embodiments, features may be directly input into a multi-layer perceptron (MLP), and a final target like a click-through rate is then calculated, to update the network in an end-to-end (end2end) manner. In addition, the network topology structure exemplified in the algorithm may be extended or simplified based on a limitation for memory occupation of a model and a requirement for detection accuracy in an actual application.

In some embodiments, a total loss function includes four parts, which are respectively an edge prediction loss function for the sampled subgraph G1, an edge prediction loss function for the sampled subgraph G2, a contrastive learning loss function between the sampled subgraph G1 and the original graph G, and a contrastive learning loss function between the sampled subgraph G2 and the original graph G.

In some embodiments, the edge prediction loss function for the sampled subgraph G1 is shown in Formula (7).

$${L}_{edge\_G 1} = - log σ ( {y}_{u , v}^{1} ) - {\sum }_{{v}_{i} - {P}_{n} ( v ) , i = 1 , … , k} log [ 1 - σ ( {y}_{u , {v}_{i}}^{1} ) ] . \qquad Formula ( 7 )$$

In formula (7),

$${y}_{u , v}^{1}$$

is a score indicating a possibility that a connection exists between a node u and a node v, Pₙ(v) represents an arbitrary noise distribution,

$${y}_{u , {v}_{i}}^{1}$$

is a score indicating a possibility that a connection exists between the node u and any noise node vᵢ, and

$${y}_{u , v}^{1}$$

may be obtained by using Formula (8).

$${y}_{u , v} = ϕ ( {h}_{u}^{( L )} , {h}_{v}^{( L )} ) . \qquad Formula ( 8 )$$

In formula (8),

$${h}_{u}^{( L )}$$

is a vector feature representation of a node u obtained after updates through a plurality of graph neural network (GNN) layers, and

$${h}_{v}^{( L )}$$

is a vector feature representation of a node v obtained after updates through a plurality of graph neural network (GNN) layers.

In some embodiments, similar to the edge prediction loss function for the sampled subgraph G1, the edge prediction loss function for the sampled subgraph G2 is shown in Formula (9).

$${L}_{edge\_G 2} = - log σ ( {y}_{u , v}^{2} ) - {\sum }_{{v}_{i} - {P}_{n} ( v ) , i = 1 , … , k} log [ 1 - σ ( {y}_{u , {v}_{i}}^{2} ) ] . \qquad Formula ( 9 )$$

In Formula (9), for meanings of parameters, refer to the meanings of the parameters in Formula (7). A difference lies in that Formula (9) is for a node in the subgraph G2, and the formula (7) is for a node in the subgraph G1.

In some embodiments, a contrastive learning loss function between the sampled subgraph G1 and the original graph G is shown in Formula (10).

$${L}_{InfoNCE\_G 1} = - log ( \frac{exp ( sim ( {h}_{i}^{0} , {h}_{i}^{1} ) / τ )}{{\sum }_{k = 1}^{N} {1}_{[ k \neq i ]} exp ( sim ( {h}_{i}^{0} , {h}_{k}^{1} ) / τ )} ) . \qquad Formula ( 10 )$$

In Formula (10),

$${h}_{i}^{0}$$

is a feature representation of an i^{th} node on the original graph G,

$${h}_{i}^{1}$$

is a feature representation of the same i^{th} node on the sampled subgraph G1. If the i^{th} node does not exist in the subgraph G1,

$${h}_{i}^{1}$$

is 0. τ is a temperature coefficient, and N is a quantity of subgraph nodes in the subgraph G1. 1[_{k≠i]} indicates that a value is 1 when k≠i, and is otherwise 0. According to Formula (10), a distance between consistent representations of nodes may be reduced, and a distance between other representations can be increased.

In some embodiments, similar to the contrastive learning loss function between the sampled subgraph G1 and the original graph G, the contrastive learning loss function between the sampled subgraph G2 and the original graph G is shown in Formula (11).

$${L}_{InfoNCE\_G 2} = - log ( \frac{exp ( sim ( {h}_{i}^{0} , {h}_{i}^{2} ) / τ )}{{\sum }_{k = 1}^{N} {1}_{[ k \neq i ]} exp ( sim ( {h}_{i}^{0} , {h}_{k}^{2} ) / τ )} ) . \qquad Formula ( 11 )$$

In Formula (11), for meanings of parameters, refer to the meanings of the parameters in Formula (10). A difference lies in that Formula (11) is for nodes in the subgraph G2 and the original graph G, and the formula (10) is for nodes in the subgraph G1 and the original graph G.

In some embodiments, the total loss function is shown in Formula (12).

L=λ₁L_{edge_G1}+λ₂L_{edge_G2}+λ₃L_{InfoNCE_G1}+λ₄L_{InfoNCE_G2} Formula (12).

In formula (12), L represents a total loss function, L_{edge_G1} represents the edge prediction loss function for the sampled subgraph G1, L_{edge_G2} represents the edge prediction loss function for the sampled subgraph G2, L_{InfoNCE_G1} represents the contrastive learning loss function between the sampled subgraph G1 and the original graph G, L_{InfoNCE_G2} represents the contrastive learning loss function between the sampled subgraph G2 and the original graph G, and λ₁, λ₂, λ₃, and λ₄ are preset hyperparameters. For example, values of λ₁, λ₂, λ₃, and λ₄ may all be 1.

The method provided in some embodiments may be widely applied to modules in an advertisement system and a recommendation system.

In retrieval, obtained user feature representations, item feature representations, and advertisement feature representations may be used, and a dot product operation may be directly performed on a user feature representation and an advertisement feature representation to perform U2I retrieval. In some embodiments, the dot product operation may be first performed on a user feature representation and an item feature representation, to obtain an item in which a user is interested, and then a dot product is performed on a feature representation of the item of interest and an advertisement feature representation, to obtain a related advertisement, thereby performing U2I2I retrieval.

In prediction of a click-through rate, a conversion rate, and the like, the obtained feature representations of the user, the item, and the advertisement may be used as dense features to input into a network for learning, or may be explicitly represented as a distance between the user and the item or between the user and the advertisement to input into the network for learning.

In some embodiments, related data such as the first object data, the to-be-recommended information, the training sample graph, the training subgraph, the second object data, and the training recommendation information is involved. Collection, use, and processing of the related data need to comply with related laws, regulations, and standards.

The following continues to describe an exemplary structure in which the information recommendation apparatus 455 provided in some embodiments is implemented as a software module. In some embodiments, as shown in FIG. 3, software modules in the information recommendation apparatus 455 stored in the memory 450 may include:

a first obtaining module 4551, configured to obtain first object data of a plurality of recommendation target objects and a plurality of pieces of to-be-recommended information; a first feature extraction module 4552, configured to separately perform feature extraction on the first object data and the to-be-recommended information by using a trained feature extraction model, to correspondingly obtain object features and information features, the trained feature extraction model being obtained by training a to-be-trained feature extraction model based on a plurality of training sample graphs and at least one training subgraph corresponding to each training sample graph, and the training subgraph being obtained by performing graph sampling on the training sample graph; a first determining module 4553, configured to determine, based on the plurality of object features and the plurality of information features, target to-be-recommended information matching each recommendation target object; and a sending module 4554, configured to send corresponding target to-be-recommended information to a terminal of each recommendation target object.

In some embodiments, the first determining module 4553 is further configured to: determine, for each recommendation target object, a target similarity between the recommendation target object and each piece of to-be-recommended information based on an object feature of the recommendation target object and each information feature; determine a highest similarity based on each target similarity; and determine, as target to-be-recommended information matching the recommendation target object, to-be-recommended information corresponding to the highest similarity.

In some embodiments, when the plurality of pieces of to-be-recommended information include at least one piece of to-be-recommended entity information and at least one piece of to-be-recommended display information, the information feature is an entity feature or a display feature, the target similarity is a first similarity between the recommendation target object and the to-be-recommended entity information, or a second similarity between the recommendation target object and the to-be-recommended display information. The first determining module 4553 is further configured to: determine a first similarity between the recommendation target object and each piece of to-be-recommended entity information based on the object feature and each entity feature; determine, based on each first similarity, a target to-be-recommended entity matching the recommendation target object; and perform a dot product operation on an entity feature of the target to-be-recommended entity and a feature of each to-be-recommended display information, to obtain a second similarity between the recommendation target object and each to-be-recommended display information. The first determining module 4553 is further configured to determine a largest value in the second similarity as the highest similarity.

In some embodiments, when all of the plurality of pieces of to-be-recommended information are to-be-recommended display information, the first determining module 4553 is further configured to: perform the dot product operation on the object feature and each information feature, to obtain a target similarity between the recommendation target object and each piece of the to-be-recommended information. The first determining module 4553 is further configured to determine a largest value in the target similarity as the highest similarity.

In some embodiments, the software module in the information recommendation apparatus 455 may further include: a second obtaining module, configured to obtain a plurality of training sample graphs, at least one training subgraph corresponding to each training sample graph, and a to-be-trained feature extraction model, the training sample graph including a plurality of graph nodes, and the training subgraph including a plurality of subgraph nodes; a second feature extraction module, configured to: determine a first node feature of each graph node in the training sample graph by using the to-be-trained feature extraction model; and determine, for each training subgraph corresponding to the training sample graph, a second node feature of each subgraph node in the training subgraph; a second determining module, configured to determine a total loss value based on each first node feature and each second node feature; and an adjustment module, configured to perform parameter adjustment on the to-be-trained feature extraction model based on the total loss value until a model training ending condition is satisfied, to obtain a trained feature extraction model.

The software module in the information recommendation apparatus 455 may further include: a third obtaining module, configured to obtain second object data of a plurality of training objects and a plurality of pieces of training recommendation information; a third determining module, configured to determine each training object and each piece of training recommendation information as graph nodes; a construction module, configured to construct a connection edge between graph nodes based on a plurality of pieces of second object data, to obtain the training sample graph; and a sampling module, configured to perform graph sampling processing on the training sample graph at least once, to obtain at least one training subgraph corresponding to the training sample graph.

In some embodiments, the second feature extraction module is further configured to: perform feature extraction on the training sample graph by using the to-be-trained feature extraction model, to obtain a first initial feature of each graph node in the training sample graph; and perform feature updating on the first initial feature of each graph node, to obtain a first node feature of each graph node.

In some embodiments, the second feature extraction module is further configured to: obtain, for each graph node, a neighboring node of the graph node from the training sample graph; and perform fusion processing on a first initial feature of the graph node and a first initial feature of the neighboring node, to obtain a first node feature of the graph node.

In some embodiments, the second feature extraction module is further configured to: randomly generate a first initial feature of each graph node in the training sample graph based on a preset dimension by using the to-be-trained feature extraction model; or separately perform, when the second object data includes object data in at least two dimensions, feature extraction on object data in different dimensions by using the to-be-trained feature extraction model, to obtain dimension object features in the different dimensions; and concatenate the dimension object features, to obtain a first initial feature of a graph node corresponding to the training object; separately perform, when the training recommendation information includes recommendation information in at least two dimensions, feature extraction on recommendation information in different dimensions by using the to-be-trained feature extraction model, to obtain dimension information features in the different dimensions; and concatenate the dimension information features, to obtain a first initial feature of a graph node corresponding to the training recommendation information.

In some embodiments, the second feature extraction module is further configured to: determine, as a second initial feature of a subgraph node, a first initial feature of a graph node that is in the training sample graph and that corresponds to the subgraph node in the training subgraph; and perform feature updating on a second initial feature of each subgraph node, to obtain a second node feature of each subgraph node.

In some embodiments, the second determining module is further configured to: determine, for each training subgraph, an update loss value of the training subgraph based on each second node feature; determine a contrastive loss value based on each first node feature and each second node feature; and perform weighting processing on each update loss value and each contrastive loss value, to obtain the total loss value.

In some embodiments, the second determining module is further configured to: determine a first connection score between a u^{th} subgraph node and a v^{th} subgraph node based on a second node feature of the u^{th} subgraph node and a second node feature of the v^{th} subgraph node, u=1, 2, . . . , N, v=1, 2, . . . , N, u being not equal to v, and N being a total quantity of subgraph nodes included in the training subgraph; obtain k noise distributions, and determine a second connection score between the u^{th} node and a noise node based on the second node feature of the u^{th} node and the noise distribution; and determine the update loss value based on the first connection score and the second connection score.

In some embodiments, the second determining module is further configured to: perform, based on the noise distribution, sampling on subgraph nodes included in the training subgraph, to obtain a noise node corresponding to the noise distribution; and determine a second connection score between the u^{th} node and the noise node based on the second node feature of the u^{th} node and a second node feature of the noise node.

In some embodiments, the second determining module is further configured to: determine a third similarity between an i^{th} graph node and an i^{th} subgraph node based on a first node feature of the i^{th} graph node and a second node feature of the i^{th} subgraph node, i=1, 2, . . . , M, and M being a total quantity of graph nodes included in the training sample graph; determine a fourth similarity between the i^{th} graph node and a k^{th} subgraph node based on the first node feature of the i^{th} graph node and a second node feature of the k^{th} subgraph node, i=1, 2, . . . , M, k=1, 2, . . . , and N, and k being not equal to i; and determine the contrastive loss value based on the third similarity and the fourth similarity.

Some embodiments provides a computer program product or a computer program. The computer program product or the computer program includes computer-executable instructions, and the computer-executable instructions are stored on a computer-readable storage medium. A processor of a computer device reads the computer-executable instructions from the computer-readable storage medium, and the processor executes the computer-executable instructions, to cause the computer device to perform the information recommendation method provided in some embodiments.

Some embodiments provides a computer-readable storage medium, having computer-executable instructions stored thereon. When the computer-executable instructions are executed by a processor, the processor is caused to perform the information recommendation method provided in some embodiments, for example, the information recommendation method shown in FIG. 4.

In some embodiments, the computer-readable storage medium may be the computer-readable storage medium may be a memory such as a ferroelectric random access memory (FRAM), a ROM, a programmable ROM (PROM), an electrically programmable ROM (EPROM), an electrically erasable programmable ROM (EEPROM), a flash memory, a magnetic surface memory, a compact disc, or a compact disc ROM (CD-ROM); or may be various devices including one of the foregoing memories or any combination thereof.

In some embodiments, the computer-executable instructions may be in the form of programs, software, software modules, scripts, or code, written in any form of programming language (which includes compiled or interpreted languages, or declarative or procedural languages), and may be deployed in any form, which includes being deployed as a standalone program or as a module, component, subroutine, or another unit suitable for use in a computing environment.

In an example, the computer-executable instructions may but do not necessarily correspond to a file in a file system, and may be stored as a part of a file having another program or data stored therein. For example, the computer-executable instructions are stored in one or more scripts in a HyperText Markup Language (HTML) text, stored in a single file dedicated to a discussed program, or stored in a plurality of collaborative files (for example, files having one or more modules, subprograms, or code parts).

In an example, the computer-executable instructions may be deployed to be executed on a computing device, or deployed to be executed on a plurality of computing devices at the same location, or deployed to be executed on a plurality of computing devices that are distributed in a plurality of locations and interconnected by using a communication network.

The foregoing descriptions are merely some embodiments, and are not intended to limit the protection scope of this application. Any modification, equivalent replacement, and improvement within the spirit and scope of this application are included in the scope of protection of this application.

What is claimed is:

1. An information recommendation method, performed by a computer device, comprising:
obtaining first object data of a plurality of recommendation target objects and a plurality of pieces of to-be-recommended information;
sampling each training sample graph of a plurality of training sample graphs to obtain at least one training subgraph corresponding to the training sample graph;
training a feature extraction model based on the plurality of training sample graphs and the at least one training subgraph corresponding to each training sample graph;
performing feature extraction on the first object data and the to-be-recommended information using the feature extraction model, to obtain object features and information features, respectively;
determining, based on the object features and the information features, target to-be-recommended information matching each recommendation target object; and
sending the target to-be-recommended information matching each recommendation target object to a terminal of the recommendation target object, to cause the terminal to display the target to-be-recommended information to the recommendation target object.

2. The method according to claim 1, wherein the determining comprises:
determining, for each recommendation target object, based on an object feature of the recommendation target object and an information feature of each piece of to-be-recommended information, a target similarity between the recommendation target object and the piece of to-be-recommended information;
determining a highest similarity from among the target similarities; and
selecting, as the target to-be-recommended information matching the recommendation target object, the to-be-recommended information corresponding to the highest similarity.

3. The method according to claim 2, wherein, based on the plurality of pieces of to-be-recommended information comprising at least one piece of to-be-recommended entity information and at least one piece of to-be-recommended display information, the information feature is an entity feature or a display feature, and the target similarity is a first similarity between the recommendation target object and the to-be-recommended entity information, or a second similarity between the recommendation target object and the to-be-recommended display information; and wherein the determining the target similarity comprises:
determining, based on the object feature and an entity feature of each piece of to-be-recommended entity information, a first similarity between the recommendation target object and the piece of to-be-recommended entity information;
determining, based on each first similarity, a target to-be-recommended entity matching the recommendation target object; and
determining, based on an entity feature of the target to-be-recommended entity and a display feature of each piece of to-be-recommended display information, a second similarity between the recommendation target object and the piece of to-be-recommended display information; and
wherein the determining the highest similarity comprises: determining the largest value among the second similarities as the highest similarity.

4. The method according to claim 2, wherein, based on all of the plurality of pieces of to-be-recommended information being to-be-recommended display information, the determining the target similarity comprises:
performing a dot product operation on the object feature and an information feature of each piece of to-be-recommended information, to obtain the target similarity between the recommendation target object and the piece of to-be-recommended information; and
wherein the determining the highest similarity comprises: determining the largest value among the target similarities as the highest similarity.

5. The method according to claim 1, wherein the training sample graph comprises a plurality of graph nodes, the training subgraph comprises a plurality of subgraph nodes, and the training the feature extraction model comprises:
for each training sample graph, determining, using the feature extraction model, a first node feature of each graph node in the training sample graph;
for each training subgraph corresponding to the training sample graph, determining a second node feature of each subgraph node in the training subgraph;
determining a total loss value based on each first node feature and each second node feature; and
performing parameter adjustment on the feature extraction model based on the total loss value until a model training ending condition is satisfied.

6. The method according to claim 5, wherein the method further comprises:
obtaining second object data of a plurality of training objects and a plurality of pieces of training recommendation information;
using each training object and each piece of the training recommendation information as graph nodes;
constructing, based on a plurality of pieces of the second object data, a connection edge between the graph nodes, to obtain the training sample graph; and
sampling the training sample graph at least once, to obtain at least one training subgraph corresponding to the training sample graph.

7. The method according to claim 6, wherein the determining the first node feature of each graph node comprises:
performing feature extraction on the training sample graph using the feature extraction model, to obtain a first initial feature of each graph node in the training sample graph; and
performing feature updating on the first initial feature of each graph node, to obtain the first node feature of each graph node.

8. The method according to claim 7, wherein the performing feature updating on the first initial feature of each graph node comprises:
obtaining, for each graph node, from the training sample graph, a neighboring node of the graph node; and
fusing the first initial feature of the graph node and the first initial feature of the neighboring node, to obtain the first node feature of the graph node.

9. The method according to claim 7, wherein the performing feature extraction on the training sample graph comprises:
randomly generating, based on a preset dimension and using the feature extraction model, a first initial feature of each graph node in the training sample graph; or
based on the second object data comprising object data in at least two dimensions, separately performing feature extraction on the object data in different dimensions using the feature extraction model, to obtain dimension object features in the different dimensions, and concatenating the dimension object features, to obtain a first initial feature of a graph node corresponding to the training object;
based on the training recommendation information comprising recommendation information in at least two dimensions, separately performing feature extraction on the recommendation information in different dimensions using the feature extraction model, to obtain dimension information features in the different dimensions, and concatenating the dimension information features, to obtain a first initial feature of a graph node corresponding to the training recommendation information.

10. The method according to claim 7, wherein the determining the second node feature of each subgraph node comprises:
using, as a second initial feature of a subgraph node, the first initial feature of the graph node that is in the training sample graph and that corresponds to the subgraph node in the training subgraph; and
performing feature updating on the second initial feature of each subgraph node, to obtain the second node feature of each subgraph node.

11. An information recommendation apparatus, comprising:
at least one memory configured to store program code; and
at least one processor configured to read the program code and operate as instructed by the program code, the program code comprising:
obtaining code configured to cause at least one of the at least one processor to obtain first object data of a plurality of recommendation target objects and a plurality of pieces of to-be-recommended information;
sampling code configured to cause at least one of the at least one processor to sample each training sample graph of a plurality of training sample graphs to obtain at least one training subgraph corresponding to the training sample graph;
training code configured to cause at least one of the at least one processor to train a feature extraction model based on the plurality of training sample graphs and the at least one training subgraph corresponding to each training sample graph;
extraction code configured to cause at least one of the at least one processor to perform feature extraction on the first object data and the to-be-recommended information using the feature extraction model, to obtain object features and information features, respectively;
matching code configured to cause at least one of the at least one processor to determine, based on the object features and the information features, target to-be-recommended information matching each recommendation target object; and
sending code configured to cause at least one of the at least one processor to send the target to-be-recommended information matching each recommendation target object to a terminal of the recommendation target object, to cause the terminal to display the target to-be-recommended information to the recommendation target object.

12. The apparatus according to claim 11, wherein the matching code is further configured to cause at least one of the at least one processor to:
determine, for each recommendation target object, based on an object feature of the recommendation target object and an information feature of each piece of to-be-recommended information, a target similarity between the recommendation target object and the piece of to-be-recommended information;
determine a highest similarity from among the target similarities; and
select, as the target to-be-recommended information matching the recommendation target object, the to-be-recommended information corresponding to the highest similarity.

13. The apparatus according to claim 12, wherein, based on the plurality of pieces of to-be-recommended information comprising at least one piece of to-be-recommended entity information and at least one piece of to-be-recommended display information, the information feature is an entity feature or a display feature, and the target similarity is a first similarity between the recommendation target object and the to-be-recommended entity information, or a second similarity between the recommendation target object and the to-be-recommended display information; and wherein the matching code is further configured to cause at least one of the at least one processor to:
determine, based on the object feature and an entity feature of each piece of to-be-recommended entity information, a first similarity between the recommendation target object and the piece of to-be-recommended entity information;
determine, based on each first similarity, a target to-be-recommended entity matching the recommendation target object; and
determine, based on an entity feature of the target to-be-recommended entity and a display feature of each piece of to-be-recommended display information, a second similarity between the recommendation target object and the piece of to-be-recommended display information; and
wherein the matching code is further configured to cause at least one of the at least one processor to determine the largest value among the second similarities as the highest similarity.

14. The apparatus according to claim 12, wherein, based on all of the plurality of pieces of to-be-recommended information being to-be-recommended display information, the matching code is further configured to cause at least one of the at least one processor to:
perform a dot product operation on the object feature and an information feature of each piece of to-be-recommended information, to obtain the target similarity between the recommendation target object and the piece of to-be-recommended information; and
determine the largest value among the target similarities as the highest similarity.

15. The apparatus according to claim 11, wherein the training sample graph comprises a plurality of graph nodes, the training subgraph comprises a plurality of subgraph nodes, and the training code is further configured to cause at least one of the at least one processor to:
for each training sample graph, determine, using the feature extraction model, a first node feature of each graph node in the training sample graph;
for each training subgraph corresponding to the training sample graph, determine a second node feature of each subgraph node in the training subgraph;
determine a total loss value based on each first node feature and each second node feature; and
perform parameter adjustment on the feature extraction model based on the total loss value until a model training ending condition is satisfied.

16. The apparatus according to claim 15, wherein the program code further comprises:
construction code configured to cause at least one of the at least one processor to obtain second object data of a plurality of training objects and a plurality of pieces of training recommendation information;
use each training object and each piece of the training recommendation information as graph nodes;
construct, based on a plurality of pieces of the second object data, a connection edge between the graph nodes, to obtain the training sample graph; and
wherein the sampling code is further configured to cause at least one of the at least one processor to sample the training sample graph at least once, to obtain at least one training subgraph corresponding to the training sample graph.

17. The apparatus according to claim 16, wherein the training code is further configured to cause at least one of the at least one processor to:
perform feature extraction on the training sample graph using the feature extraction model, to obtain a first initial feature of each graph node in the training sample graph; and
perform feature updating on the first initial feature of each graph node, to obtain the first node feature of each graph node.

18. The apparatus according to claim 17, wherein the training code is further configured to cause at least one of the at least one processor to:
obtain, for each graph node, from the training sample graph, a neighboring node of the graph node; and
fuse the first initial feature of the graph node and the first initial feature of the neighboring node, to obtain the first node feature of the graph node.

19. The apparatus according to claim 17, wherein the training code is further configured to cause at least one of the at least one processor to:
randomly generate, based on a preset dimension and using the feature extraction model, a first initial feature of each graph node in the training sample graph; or
based on the second object data comprising object data in at least two dimensions, separately perform feature extraction on the object data in different dimensions using the feature extraction model, to obtain dimension object features in the different dimensions, and concatenate the dimension object features, to obtain a first initial feature of a graph node corresponding to the training object;
based on the training recommendation information comprising recommendation information in at least two dimensions, separately perform feature extraction on the recommendation information in different dimensions using the feature extraction model, to obtain dimension information features in the different dimensions, and concatenate the dimension information features, to obtain a first initial feature of a graph node corresponding to the training recommendation information.

20. A non-transitory computer-readable storage medium, storing computer code which, when executed by at least one processor, causes the at least one processor to at least:
obtain first object data of a plurality of recommendation target objects and a plurality of pieces of to-be-recommended information;
sample each training sample graph of a plurality of training sample graphs to obtain at least one training subgraph corresponding to the training sample graph;
train a feature extraction model based on the plurality of training sample graphs and the at least one training subgraph corresponding to each training sample graph;
perform feature extraction on the first object data and the to-be-recommended information using the feature extraction model, to obtain object features and information features, respectively;
determine, based on the object features and the information features, target to-be-recommended information matching each recommendation target object; and
send the target to-be-recommended information matching each recommendation target object to a terminal of the recommendation target object, to cause the terminal to display the target to-be-recommended information to the recommendation target object.
